(19) United States
(12) Patent Application Publication
(10) Pub. No.: US 2021/0131609 A1
(43) Pub. Date: May 6, 2021

(54) HANDHELD GIMBAL

(71) Applicant: SZ DJI TECHNOLOGY CO., LTD., Shenzhen (CN)

(72) Inventor: Tianfei ZHAO, Shenzhen (CN)

(73) Assignee: SZ DJI TECHNOLOGY CO., LTD., Shenzhen (CN)

(21) Appl. No.: 17/125,699

(22) Filed: Dec. 17, 2020

Related U.S. Application Data
(63) Continuation of application No. PCT/CN2019/088623, filed on May 27, 2019.

(51) Int. Cl. F16M 13/04; F16M 11/12; F16M 11/18

(52) U.S. Cl. CPC F16M 13/04; G03B 17/561; F16M 11/18; F16M 11/123

(57) ABSTRACT

A handheld gimbal includes a handheld part, a first shaft assembly, a second shaft assembly, a third shaft assembly, a rotating connector, and a carrier. A gimbal structure is mounted on the handheld part. The handheld gimbal can be switched between a folded state and a deployed state. In the folded state, the second shaft assembly, the third shaft assembly and the carrier are located on the same lateral side of the handheld part. In the deployed state, the second shaft assembly, the third shaft assembly and the carrier are located on the same longitudinal side of the handheld part. A rotation axis around which a first arm and a second arm rotate relative to each other is perpendicular to a length direction of the first arm. The small size of the handheld gimbal after folding allows the handheld gimbal to be easily carried and stored.

### RELATED APPLICATIONS

This application is a continuation application of PCT application No. PCT/CN2019/088623, filed on May 27, 2019, and the content of which is incorporated herein by reference in its entirety.

### TECHNICAL FIELD

This disclosure relates to the field of gimbal technologies, and in particular, to a handheld gimbal.

### BACKGROUND

Currently, portable photographing apparatuses, such as mobile phones and digital cameras are becoming more and more popular. These photographing apparatuses can meet the user requirement of photographing anytime and anywhere. Handheld gimbals are used because ordinary users usually do not have professional photographing knowledge. A handheld gimbal allows a photographing apparatus mounted thereon to remain stable during photographing to capture clear pictures and videos. However, a conventional handheld stabilizer is not compact when folded, resulting in a large folded size, making it inconvenient for a user to carry. In addition, after being folded, the conventional handheld stabilizer usually cannot clamp a photographing tool. Therefore, a user needs to store a handheld gimbal and a photographing apparatus separately for device storage, resulting in cumbersome storage steps for the conventional foldable handheld stabilizer.

### SUMMARY

Embodiments of this disclosure provide a handheld gimbal.

This disclosure provides a handheld gimbal, including: a handheld part including a top portion and a bottom portion; a first shaft assembly including a first shaft motor connected to the top portion of the handheld part, and a first arm; a second shaft assembly including a second shaft motor and a second arm fixedly connected to the second shaft motor; a rotating connector disposed between the first arm and the second arm to allow the first arm and the second arm to rotate relative to each other; a third shaft assembly including a third shaft motor and a third arm, one end of the third arm being fixedly connected to the second shaft motor, and the other end of the third arm being fixedly connected to the third shaft motor; and a carrier fixedly connected to a rotor of the third shaft motor, where the handheld gimbal is configured to switch between a folded state and a deployed state, in the folded state, the second shaft assembly, the third shaft assembly and the carrier are located on a same lateral side of the handheld part, in the deployed state, the second shaft assembly, the third shaft assembly and the carrier are located on a same longitudinal side of the handheld part, and a rotation axis around which the first arm and the second arm rotate relative to each other is perpendicular to a length direction of the first arm.

When the handheld gimbal of this disclosure is in the folded state, the second shaft assembly and the third shaft assembly are located on the same lateral side of the handheld part. The small size of the handheld gimbal after folding allows the handheld gimbal to be easily carried, thereby meeting a user requirement for portability. In addition, the folding method is simple and easy to operate, so that a user requirement can be well met.

Additional aspects and advantages of this disclosure will be partially provided in the following description, part of which will become clear in the following description, or be learned through the practice of the implementation of this disclosure.

### BRIEF DESCRIPTION OF THE DRAWINGS

The foregoing and/or additional aspects and advantages of this disclosure will become apparent and readily understandable from the description of the implementations with reference to the following accompanying drawings.

FIG. 1 is a schematic structural diagram of a handheld gimbal in a deployed state according to some exemplary embodiments of this disclosure;

FIG. 2 is a schematic structural diagram of a handheld gimbal in a folded state according to some exemplary embodiments of this disclosure;

FIG. 3 is another schematic structural diagram of a handheld gimbal in a folded state according to some exemplary embodiments of this disclosure;

FIG. 4 is still another schematic structural diagram of a handheld gimbal in a folded state according to some exemplary embodiments of this disclosure;

FIG. 5 is another schematic structural diagram of a handheld gimbal in a deployed state according to some exemplary embodiments of this disclosure;

FIG. 6 is still another schematic structural diagram of a handheld gimbal in a deployed state according to some exemplary embodiments of this disclosure;

FIG. 7 is a partial exploded schematic diagram of a handheld gimbal according to some exemplary embodiments of this disclosure;

FIG. 8 is an enlarged schematic diagram of VIII in the handheld gimbal in FIG. 7;

FIG. 9 is a schematic cross-sectional diagram along line IX-IX of the handheld gimbal in FIG. 1; and

FIG. 10 is an enlarged schematic diagram of X in the handheld gimbal in FIG. 9.

Description of main reference numerals: Handheld gimbal 100, handheld part 10, gimbal structure 20, first shaft assembly 21, first shaft motor 210, first arm 211, first convex part 2111, through hole 2112, second arm 212, second convex part 2121, second shaft assembly 22, second shaft motor 220, third arm 221, third shaft assembly 23, third shaft motor 230, carrier 231, mounting side 2311, first axis Y, second axis P, third axis R, rotating connector 30, elastic member 31, first component 32, first convex-concave part 321, second component 33, second convex-concave part 331, shaft 34, flange 341, recess 342, sleeve 35, clamping member 36, first cover 37, and second cover 38.

### DETAILED DESCRIPTION

Embodiments of this disclosure will be described in detail below, and exemplary embodiments are shown in the accompanying drawings. Same or similar reference numerals throughout the accompanying drawings indicate same or similar components or components having the same or similar functions. The exemplary embodiments described below with reference to the accompanying drawings are exemplary, are used only for explaining this disclosure, and should not be construed as a limitation to this disclosure.

In the description of this disclosure, it should be understood that terms such as “first” and “second” are used merely for a descriptive purpose, and should not be construed as indicating or implying a relative importance, or implicitly indicating the number of indicated technical features. Therefore, the features defined by “first” and “second” can explicitly or implicitly include one or more features. In the description of this disclosure, “a plurality of” means two or more, unless otherwise clearly and specifically defined.

In the description of this disclosure, it should be noted that unless otherwise expressly specified and defined, terms such as “mounted”, “connected to each other”, and “connected to” should be viewed in a broad sense. For example, a connection may be a fixed connection, a detachable connection, or an integral connection; or a mechanical connection, an electrical connection, or mutual communication; or a direct connection, or an indirect connection through an intermediate medium, or internal communication between two elements, or an interactive relationship between two elements. A person of ordinary skill in the art may understand specific meanings of the foregoing terms in this disclosure based on a specific situation.

The disclosure below provides a number of different implementations or examples used to implement different structures of this disclosure. To simplify the disclosure of this disclosure, components and dispositions of particular examples are described below. Certainly, the following descriptions are only examples and are not intended to limit this disclosure. In addition, reference numerals and/or reference letters may be repeated in different examples in this disclosure, and such repetition is for purposes of simplification and clarity and is not indicative of relationships between the various implementations and/or dispositions discussed. In addition, while this disclosure provides examples of various specific processes and materials, a person of ordinary skill in the art may be aware of disclosures of other processes and/or use of other materials.

Some exemplary embodiments of this disclosure will be described in detail below, and examples of the implementations are shown in the accompanying drawings. Same or similar reference numerals throughout the accompanying drawings indicate same or similar components or components having the same or similar functions. The exemplary embodiments described below with reference to the accompanying drawings are exemplary, are used only for explaining this disclosure, and should not be construed as a limitation to this disclosure.

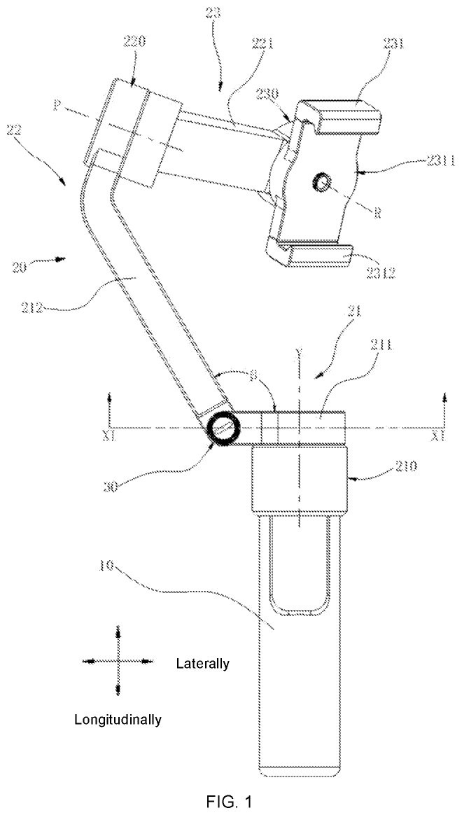

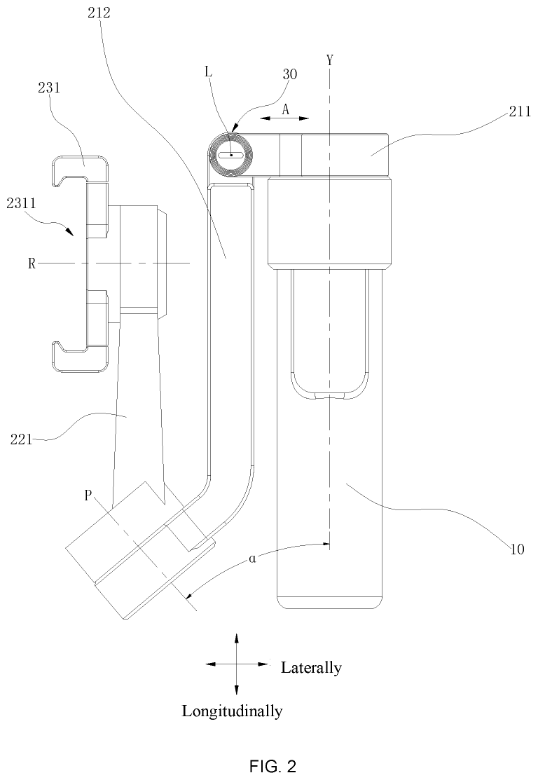

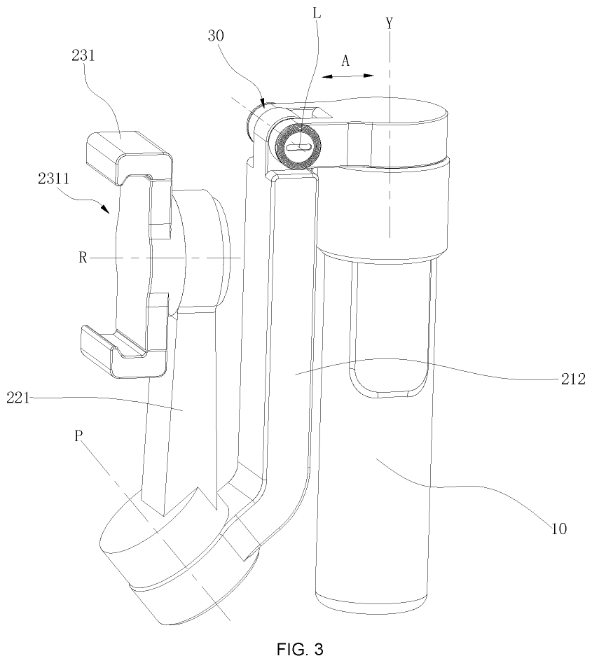

Referring to FIG. 1, FIG. 2, and FIG. 3, a handheld gimbal 100 in some exemplary embodiments of this disclosure includes a handheld part 10 and a gimbal structure 20, and the gimbal structure 20 is mounted on the handheld part 10. The gimbal structure 20 includes a first shaft assembly 21, a second shaft assembly 22, a third shaft assembly 23, a rotating connector 30, and a carrier 231.

The gimbal structure 20, which is used for stabilizing an object it carries, may be detachably connected not only to the handheld part 10 but also to another carrier, such as an unmanned aerial vehicle, a vehicle, or a ground remote control carrier. This gimbal structure can be quickly connected to the carrier, so that the gimbal structure can be switched between different carriers. For example, the gimbal structure may be switched between an unmanned aerial vehicle and the handheld part 10, or the gimbal structure may be switched between a ground remote control carrier and the handheld part.

In some exemplary embodiments, the gimbal mechanism 20 is connected to the handheld part 10. The handheld part 10 has a top portion and a bottom portion. The first shaft assembly 21 may include a first shaft motor 210 connected to the top portion, and a first arm 211. The second shaft assembly 22 may include a second shaft motor 220, and a second arm 212. The third shaft assembly 23 may include a third shaft motor 230, and a third arm 221.

In some exemplary embodiments of this disclosure, the rotating connector 30 is disposed between the first arm 211 and the second arm 212. One end of the first arm 211 is fixedly connected to the first shaft motor 210. The other end of the first arm 211 is rotatably connected to the second arm 212 through the rotating connector 30. One end of the second arm 212 away from the first arm 211 and rotatably connected to the second arm 212 is fixedly connected to the second shaft motor 220. One end of the third arm 221 is fixedly connected to the second shaft motor 220. The other end of the third arm 221 is fixedly connected to the third shaft motor 230. Further, the carrier 231 is fixedly connected to a rotor of the third shaft motor 230.

The handheld gimbal 100 can be switched between a folded state (for example, the state shown in FIG. 2) and a deployed state (for example, the state shown in FIG. 1). When the handheld gimbal 100 is in the folded state, the second shaft assembly 22 and the third shaft assembly 23 are located on a same lateral side of the handheld part 10. When the handheld gimbal 100 is in the deployed state, the second shaft assembly 22 and the third shaft assembly 23 are located on a same longitudinal side of the handheld part 10. A rotation axis L about which the first arm 211 and the second arm 212 rotate relative to each other is perpendicular to a length direction A of the first arm 211.

The handheld gimbal 100 provided in some exemplary embodiments of this disclosure may be configured to carry a photographing apparatus such as a mobile phone, a tablet computer, a camera, or a video camera to fix the photographing apparatus and adjust its posture (for example, to change a height, a tilt, and/or a direction of the photographing apparatus) and to stabilize the photographing apparatus in a determined posture.

It is understood that currently, portable photographing apparatuses, such as mobile phones and digital cameras are becoming more and more popular. These photographing apparatuses can meet a user requirement of photographing anytime and anywhere. In this disclosure, the handheld gimbal 100 may be folded or deployed. When the handheld gimbal 100 is not in use, the second arm 212, the first arm 211, or both the second arm 212 and the first arm 211 may be rotated so that the second shaft assembly 22, the third shaft assembly 23, and the carrier 231 are located on the same lateral side of the handheld part 10. In this way, the handheld gimbal 100 is folded for easy storage and carrying. When the handheld gimbal 100 needs to be used, the second arm 212 and the third arm 221 may be rotated so that the second shaft assembly 22, the third shaft assembly 23, and the carrier 231 are located on the same longitudinal side of the handheld part 10 for easy use by a user. It should be noted that, an extension direction of the handheld part 10 is referred to as the longitudinal direction, and a direction perpendicular to the extension direction of the handheld part 10 is referred to as a lateral direction. That is, when the handheld gimbal 100 is folded, the second shaft assembly 22, the third shaft assembly 23, and the carrier 231 are located on a side perpendicular to the extension direction of the handheld part 10. When the handheld gimbal is deployed for use, the second shaft assembly 22, the third shaft assembly 23, and the carrier 231 are located on a side of the extension direction of the handheld part 10.

In summary, when the handheld gimbal 100 in some exemplary embodiments of this disclosure is in the folded state, the second shaft assembly 22 and the third shaft assembly 23 are located on the same lateral side of the handheld part 10, so that the size of the handheld gimbal 100 becomes smaller, thereby enabling the handheld gimbal 100 to be easily carried, and meeting a user requirement for portability.

In some cases, when the handheld gimbal 100 is switched from the deployed state to the folded state, a motor may be directly switched from a power-on mode to a power-off mode. On the contrary, when the handheld gimbal 100 is switched from the folded state to the deployed state, each motor may be switched from the power-off mode to the power-on mode for direct use. For example, when the handheld gimbal 100 is switched from the deployed state to the folded state, the first arm 211 and the second arm 212 rotate relative to each other. When the first arm 211 and the second arm 212 rotate relative to each other so that an angle between an extension direction of the first arm 211 and the extension direction of the handheld part 10 is less than a particular angle, at least one of the first shaft motor 210, the second shaft motor 220 and the third shaft motor 230 is switched from the power-on mode to the power-off mode.

That the angle between the extension direction of the first arm 211 and the extension direction of the handheld part 10 is less than a particular angle may be that the angle between the extension direction of the first arm 211 and the extension direction of the handheld part 10 is less than 90 degrees, 80 degrees, 70 degrees, 45 degrees, or the like. This is not specifically limited herein.

That at least one of the first shaft motor 210, the second shaft motor 220 and the third shaft motor 230 is switched from the power-on mode to the power-off mode may be that only the first shaft motor 210, only the second shaft motor 220, or only the third shaft motor 230 is switched from the power-on mode to the power-off mode. Certainly, alternatively, two of the motors, for example, the first shaft motor 210 and the second shaft motor 220, the first shaft motor 210 and the third shaft motor 230, or the second shaft motor 220 and the third shaft motor 230 may be switched from the power-on mode to the power-off mode. Certainly, alternatively, all the three motors may be switched from the power-on mode to the power-off mode.

Therefore, when the handheld gimbal is switched from the deployed state to the folded state, the motor(s) may be directly switched from the power-on mode to the power-off mode, or when the handheld gimbal is switched from the folded state to the deployed state, the motor(s) may be directly switched from the power-off mode to the power-on mode, thereby saving battery power of the handheld gimbal and helping a user more easily operate the handheld gimbal.

The handheld gimbal 100 in this disclosure is a tri-axial gimbal. Specifically, in the implementation shown in the figure, the first shaft assembly 21 is a yaw-axis assembly, the second shaft assembly 22 is a pitch-axis assembly, and the third shaft assembly 23 is a roll-axis assembly. In this way, the posture of the handheld gimbal 100 can be controlled by using these three shaft assemblies, to control the posture of the photographing apparatus mounted on the handheld gimbal 100, so that the photographing apparatus is stabilized in a determined posture to capture clear pictures and videos. It may be understood that, in other exemplary embodiments, the first shaft assembly 21 may be another type of shaft assembly, the second shaft assembly 22 may be another type of shaft assembly, and the third shaft assembly 23 may also be another type of shaft assembly.

It may be understood that, when one or two of the shaft assemblies of the tri-axial gimbal are locked and thus cannot be rotated, the tri-axial gimbal may be used as a biaxial gimbal or a uniaxial gimbal.

Still referring to 2, in some exemplary embodiments, when the handheld gimbal 100 is in the folded state, the second arm 212 and the third arm 221 are arranged sequentially in a direction away from the handheld part 10.

Specifically, in the implementation shown in the figure, the second arm 212 is located between the handheld part 10 and the third arm 221, and the third shaft assembly 23 is located on a side of the third arm 221 facing away from the second arm 212.

This can facilitate mounting, disassembly, and use of a photographing apparatus on the third shaft assembly 23. Specifically, when the handheld gimbal 100 needs to be folded, the photographing apparatus can be maintained mounted on the third shaft assembly 23 during the folding process without a need to remove the photographing apparatus, thereby facilitating use by a user and saving time for mounting during use next time. When the photographing apparatus does not need to be used, the photographing apparatus may be directly disassembled without a need to deploy the handheld gimbal 100.

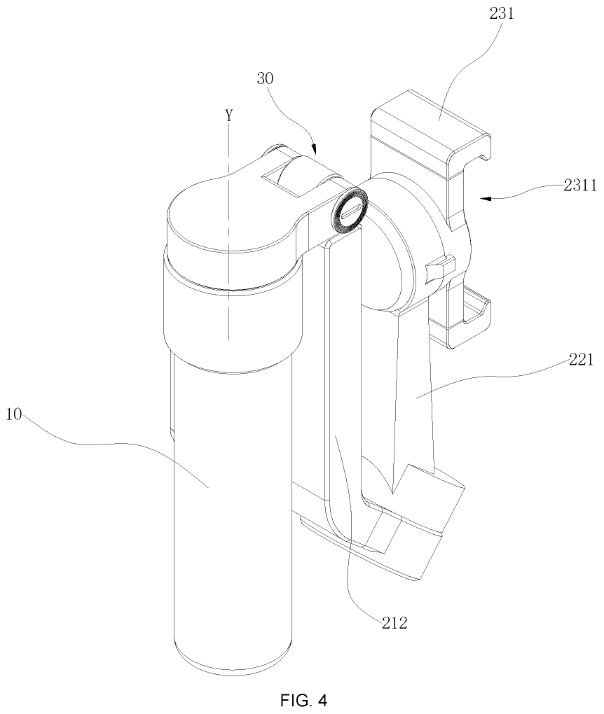

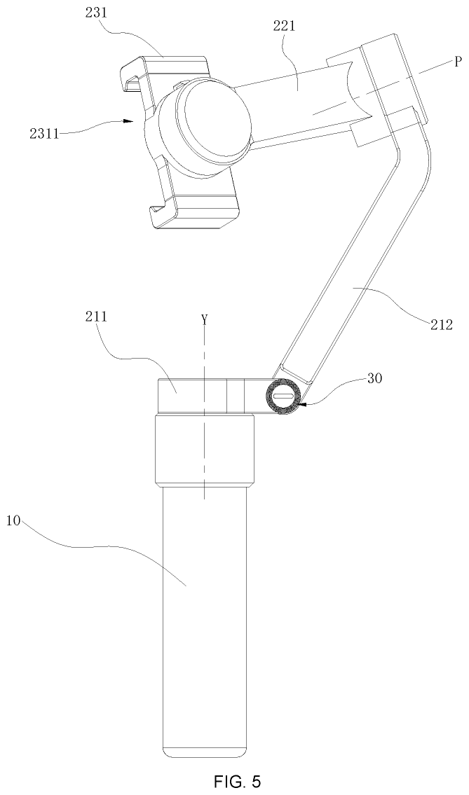

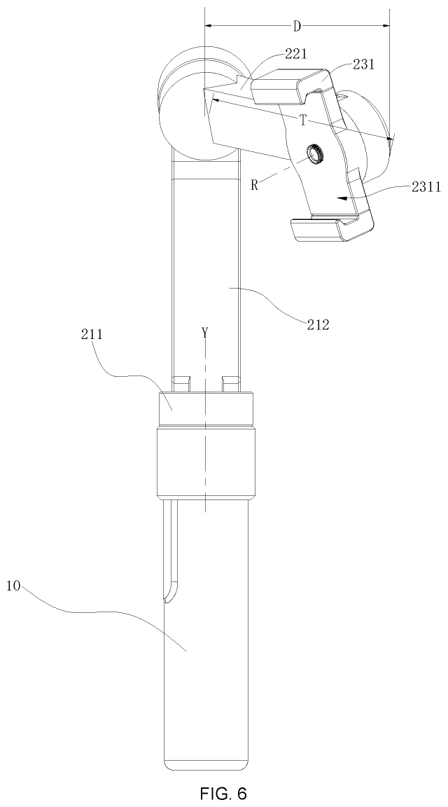

Referring to FIG. 1 to FIG. 6, in some exemplary embodiments, the first shaft motor 210 rotates around a first axis Y, the second shaft motor 220 rotates around a second axis P, and the third shaft motor 230 rotates around a third axis R. When the handheld gimbal 100 is in the deployed state, the first axis Y, the second axis P and the third axis R are all non-orthogonal (as shown in FIG. 1, FIG. 5, and FIG. 6). When the handheld gimbal 100 is in the folded state, the first axis Y and the third axis R are orthogonal, and the first axis Y and the second axis P are non-orthogonal (as shown in FIG. 2, FIG. 3, and FIG. 4).

Specifically, in some exemplary embodiments, the first shaft assembly 21 includes the first shaft motor 210, and the first shaft motor 210 is mounted on a top portion of the handheld part 10. A drive axis of the first shaft motor 210 overlaps or is parallel to the first axis Y. The first shaft motor 210 is configured to drive the first arm 211 to rotate around the first axis Y, so as to drive the second shaft assembly 22 and the third shaft assembly 23 to also rotate around the first axis Y. The first arm 211 may be a rotor of the first shaft motor 210, or a part of a rotor of the first shaft motor 210, or a component connected to a rotor of the first shaft motor 210.

The second shaft assembly 22 includes the second shaft motor 220 and the second arm 212 fixedly connected to the second shaft motor 220. A drive axis of the second shaft motor 220 overlaps or is parallel to the second axis P. The second shaft motor 220 is configured to drive the third arm 221 to rotate around the second axis P, so as to drive the third shaft assembly 23 and the carrier 231 to rotate around the second axis P together. The second arm 212 may be connected to a stator of the second shaft motor 220. The third arm 221 may be a rotor of the second shaft motor 220, or a part of a rotor of the second shaft motor 220, or a component connected to a rotor of the second shaft motor 220.

The third shaft assembly 23 includes the third shaft motor 230 and the third arm 221. A drive axis of the third shaft motor 230 overlaps or is parallel to the third axis R. The third shaft motor 230 is configured to drive the carrier 231 to rotate around the third axis R, so as to drive the carrier 231 to rotate around the third axis R.

The carrier 231 is fixedly connected to the rotor of the third shaft motor 230. In some examples, the carrier 231 may carry an imaging lens. The imaging lens is fixedly connected to the rotor of the third shaft motor 230 directly or indirectly. In some examples, the carrier 231 may further include a carrying portion configured to fix a photographing apparatus. The photographing apparatus may be a camera, an intelligent terminal with a photographing function (such as a mobile phone or a tablet computer), or another apparatus with a photographing function. It may be understood that, same or similar descriptions or illustrations below may be understood by reference to the description herein.

In this way, when the handheld gimbal 100 is in the deployed state, the handheld gimbal 100 may use the first shaft motor 210, the second shaft motor 220 and the third shaft motor 230 to drive the carrier 231 to move, so as to adjust the posture of the carrier 231 (for example, to change a height, a tilt, and/or a direction of the carrier). In addition, when the handheld gimbal 100 is in the deployed state, the first axis Y, the second axis P and the third axis R are designed non-orthogonal, so that the handheld gimbal 100 has no locking angle during movement, preventing two shaft assemblies from axially overlapping, thereby avoiding a case of lacking a degree of freedom of one shaft assembly. In addition, in the deployed state, the first axis Y, the second axis P and the third axis R are designed non-orthogonal, so that the handheld gimbal 100 is smaller and easier to store after being folded. In addition, in the implementation shown in the figure, in the folded state, the first axis Y and the third axis R are orthogonal, and the first axis Y and the second axis P are non-orthogonal, so that when the handheld gimbal 100 is folded, a space between the second arm 212 and the third arm 221 is relatively small and the handheld gimbal 100 is small, and thus easy to store and carry after being folded.

Referring to FIG. 2, in some exemplary embodiments, in the folded state, an angle α between the second axis P and the first axis Y is an acute angle.

In this way, when the handheld gimbal 100 is in the folded state, a space between the second arm 212 and the third arm 221 is relatively small, so that the handheld gimbal 100 is small, and thus is easy to carry after being folded. In addition, the angle between the second axis P and the first axis Y is an acute angle, so that the third arm 221 and the third shaft assembly 23 are located on an outer side of the second arm 212 instead of being located between the second arm 212 and the handheld part 10. In this way, folding can be performed without removing the photographing apparatus from the third shaft assembly 23, thereby facilitating use by a user.

Still referring to FIG. 2, the second arm 212 of the handheld gimbal 100 includes a first segment and a second segment that have an angle. For example, the angle may be an obtuse angle. The first segment of the second arm 212 is connected to the rotating connector 30, and the second segment is connected to the second shaft motor 220. Further, an angle between the second axis P and an extension direction of the first segment is approximately the same as an angle between the second axis P and an extension direction of the third arm 221. In some exemplary embodiments, there is an acute angle between the second axis P and the extension direction of the first segment, and there is also an acute angle approximately the same between the third arm 221 and the second axis P.

The carrier 231 may directly include an imaging lens, or may include a carrying portion configured to fix the photographing apparatus. If the carrier 231 directly includes an imaging lens, a housing of the imaging lens may be fixedly connected to the rotor of the third shaft motor 230 directly.

In some exemplary embodiments of this disclosure, that the carrier includes a carrying portion configured to fix the photographing apparatus is used as an example for description. When the handheld gimbal 100 is switched to the folded state, the carrying portion is located on a side of the third shaft motor 230 away from a side wall of the handheld part 10. Referring to FIG. 1 to FIG. 6, the carrier 231 includes a mounting side 2311. When the handheld gimbal 100 is in the folded state, the mounting side 2311 faces away from the handheld part 10. Specifically, the photographing apparatus may be mounted on the mounting side 2311. For example, the photographing apparatus is a mobile phone, and the mobile phone may be clamped on or attached to the mounting side 2311.

In this way, during folding of the handheld gimbal 100, because the mounting side 2311 faces away from the handheld part 10, a load clamped on the mounting side 2311 does not need to be removed before the folding, so that the load does not need to be remounted when the handheld gimbal 100 is deployed, making it easy to use.

In addition, in some exemplary embodiments, a part at which the carrier 231 is engaged with the photographing apparatus (for example, a mobile phone) may be made of a soft elastic material such as silicone or rubber, to prevent from scratching the photographing apparatus.

In the implementation shown in the figure, the carrying portion is a clamping structure, and the clamping structure is provided with a clamping opening. To facilitate mounting photographing apparatuses of different sizes to the carrier 231, the clamping structure may include a clamping arm 2312 that can adjust a size of the clamping opening.

When the handheld gimbal 100 is switched to the folded state, the opening of the clamping structure is disposed facing away from the third shaft motor 230. The manner in which the opening of the clamping structure is disposed can ensure that the photographing apparatus can face outward when the handheld gimbal 100 is folded, making it easier for a user to use the photographing apparatus.

Further, the clamping structure in some exemplary embodiments has a locked state and an unlocked state. When the clamping structure is in the unlocked state, the clamping structure can clamp and fix the photographing apparatus, and the third shaft motor 230 can rotate around the third axis R. When the clamping structure is in the locked state, the clamping structure is locked to the third arm 221, to limit rotation of the third shaft motor 230. In some examples, when the handheld gimbal is switched to the folded state, the clamping structure automatically switches to the locked state. In some examples, when the handheld gimbal is switched to the folded state, the clamping structure is still in the unlocked state, and a user needs to manually switch the clamping structure to the locked state. In addition, when the clamping structure is in the locked state, the clamping structure may be switched from the locked state to the unlocked state based on a manner of automatic unlocking (key/button unlocking) or manual unlocking. A structure through which the clamping structure is locked to the third arm 221 may be a conventional structure. This is not described herein.

It may be understood that, in some exemplary embodiments, the carrier 231 may also include a magnetic connector.

Specifically, when the magnetic connector is used, a magnetic housing of a photographing apparatus or a photographing apparatus with a metal that can be magnetically attracted may be placed directly on the carrier 231, and the magnetic connector attracts the photographing apparatus to fix the photographing apparatus to the carrier 231, so that the photographing apparatus can be fixed without providing an additional clamping arm, making it simpler and easier to operate.

Referring to both FIG. 1 and FIG. 6, in some exemplary embodiments, the second shaft assembly 22 includes the second shaft motor 220. The third arm 221 is connected to the second shaft motor 220 and the third shaft assembly 23. The second shaft motor 220 is configured to drive the third shaft assembly 23 to rotate around the second axis P. A radius D by which the third shaft assembly 23 rotates around the second axis P is shorter than a length T of the third arm 221.

In this way, when the handheld gimbal 100 is in the deployed state, a lateral size of the handheld gimbal 100 is relatively small, making it easier to use and carry. In addition, during folding the structure of the handheld gimbal 100, the space between the third arm 221 and the second arm 212 is smaller, so that the handheld gimbal 100 has a smaller size in the folded state. In addition, when the third arm 221 is rotated in the folded state, the third shaft assembly 23 does not interfere with the second arm 212.

In some exemplary embodiments, when the handheld gimbal 100 is in the deployed state, an angle β formed between the first arm 211 and the second arm 212 is an obtuse angle.

In this way, when the handheld gimbal 100 is deployed, the second arm 212 is located on the outer side of the handheld part 10, so that the handheld gimbal 100 has a wider movement range during operation, and it is easier to maintain balance of the gimbal, thereby allowing a wider and more stable movement range of the photographing apparatus connected to the third shaft assembly 23 while maintaining the handheld part 10 stationary.

Referring to FIG. 2, in some exemplary embodiments, in the folded state, the second arm 212 is parallel to the handheld part 10 or the angle formed between the second arm 212 and the handheld part 10 is an acute angle.

In this way, when the handheld gimbal 100 is in the folded state, the space between the second arm 212 and the handheld part 10 is relatively small, so that the handheld gimbal 100 is smaller and easier to store and carry. In the implementation shown in the figure, the second arm 212 is parallel to the handheld part 10.

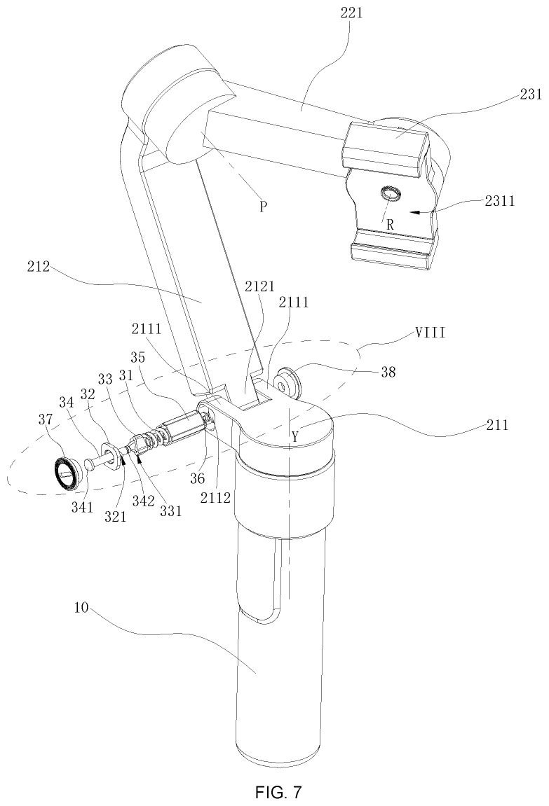

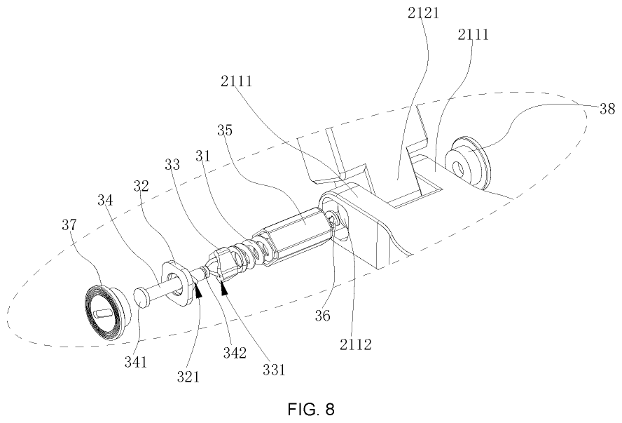

Referring to FIG. 1, FIG. 2, FIG. 7, and FIG. 8, in some manners, the first arm 211 is rotatably connected to the second arm 212 via the rotating connector 30.

In this way, the second arm 212 can rotate around the first arm 211 via the rotating connector 30, so that the handheld gimbal 100 can be switched between the folded state and the deployed state.

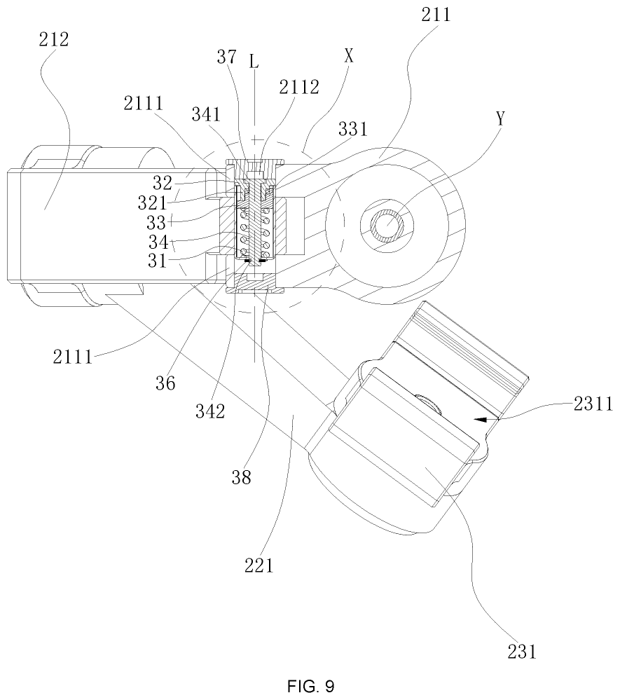

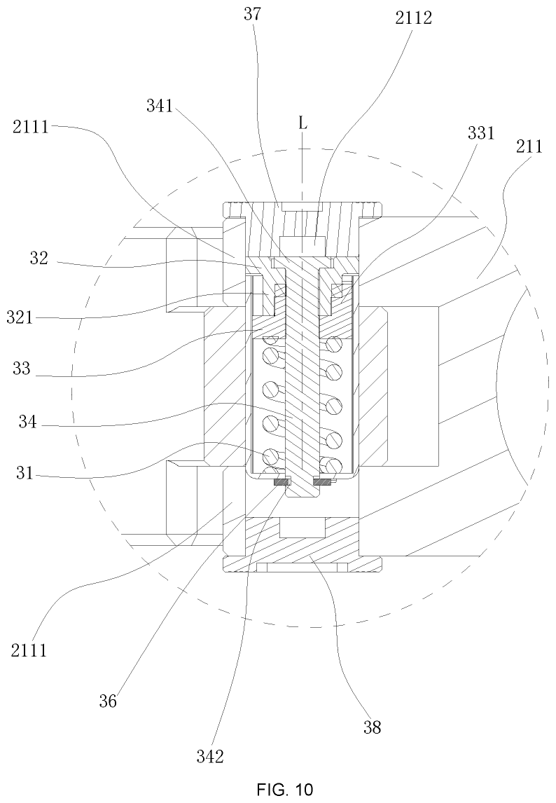

Referring to FIG. 7 to FIG. 10, in some exemplary embodiments, the rotating connector 30 may include an elastic member 31, a first component 32, and a second component 33. The first component 32 is disposed on the first arm 211, and the second component 33 is disposed on the second arm 212. The first component 32 and the second component 33 may rotate relative to each other. The elastic member 31 is connected to the second component 33. The elastic member 31 is configured to drive the second component 33 to be engaged with the first component 32, so as to lock the relative positions of the first arm 211 and the second arm 212.

It may be understood that, in some exemplary embodiments, the elastic member 31 may drive the second component 33 to be engaged with the first component 32, so as to lock the positions of the first arm 211 and the second arm 212, to maintain the handheld gimbal 100 in the deployed state, the folded state, or an intermediate state between the folded state and the deployed state. In addition, the second arm 212 may further rotate relative to the first arm 211 under an action of an external force, or the first arm 211 may rotate relative to the second arm 212 under an action of an external force. During rotation, the first component 32 disengages from the second component 33, so that the second arm 212 and the first arm 211 can smoothly rotate relative to each other. When the external force is withdrawn, the second component 33 is engaged with the first component 32 again under an action of the elastic member 31, so as to maintain the relative positions of the second arm 212 and the first arm 211.

In this way, the rotating connector 30 can be disposed to enable the handheld gimbal 100 to switch freely and stay between the folded state and the deployed state. For example, when the handheld gimbal 100 is in the deployed state, the first component 32 and the second component 33 of the rotating connector 30 may remain engaged with each other to maintain the handheld gimbal 100 in the deployed state, so that the handheld gimbal 100 can work properly.

It may be understood that, in some exemplary embodiments of this disclosure, the second arm 212 can rotate around the first arm 211 within a range of 0° to 180°, and can stay at a preset angle ranging from 0° to 180°. The preset angle can be set based on an angle at which the first component 32 is engaged with the second component 33. It may be understood that, in another implementation, the elastic member 31 may be alternatively connected to the first component 32. The elastic member 31 is configured to drive the first component 32 to be engaged with the second component 33, so as to lock the relative positions of the first arm 211 and the second arm 212. A specific disposition manner is not limited herein.

Referring to FIG. 7 to FIG. 10, in some exemplary embodiments, one end of the first arm 211 is provided with two first convex parts 2111 spaced opposite to each other, and one end of the second arm 212 is provided with a second convex part 2121. The second convex part 2121 is at least partially located between the two first convex parts 2111. The elastic member 31 is connected to the second component 33. The rotating connector 30 includes a shaft 34 and a sleeve 35. The sleeve 35 is at least disposed through the second convex part 2121, and is fixedly connected to the second convex part 2121. The second component 33 and the elastic member 31 are accommodated in the sleeve 35. The shaft 34 is disposed through the first component 32, the second component 33 and the elastic member 31.

Specifically, in the implementation shown in the figure, two ends of the elastic member 31 respectively abut against an inner surface of the sleeve 35 and the second component 33. The second component 33 may have a tendency to move out of the sleeve 35 under an acting force of the elastic member 31, so that the first component 32 and the second component 33 can be maintained engaged with each other. The sleeve 35 is disposed through the second convex part 2121, and is partially disposed through the first convex part 2111. The sleeve 35 and the second convex part 2121 do not rotate relative to each other. The sleeve 35 can rotate relative to the first convex part 2111. The second convex part 2121 is rotatably connected to the first convex part 2111 via the sleeve 35. The first component 32 is disposed on the first convex part 2111 and does not rotate relative to the first convex part 2111. The second component 33 is disposed in the sleeve 35. That the sleeve 35 is fixedly connected to the second convex part 2121 may be understood as a case in which the sleeve 35 and the second convex part 2121 do not rotate relative to each other. The elastic member 31 may be an elastic component such as a spring.

In this way, when the second arm 212 is forced to rotate, the second arm 212 drives the sleeve 35 to rotate, to drive the second component 33 to rotate relative to the first component 32, so that the first component 32 and the second component 33 interact with and thus disengage from each other, thereby allowing the second arm 212 to rotate relative to the first arm 211 smoothly. When the force on the second arm 212 is withdrawn, the second component 33 is engaged with the first component 32 again under an action of the elastic member 31 to lock the relative positions of the second arm 212 and the first arm 211, so as to maintain the second arm 212 and the first arm 211 in a relatively non-rotating state.

In addition, in the foregoing implementation, one end of the shaft 34 is provided with a ring-shaped flange 341, and the other end thereof is provided with a recess 342. The rotating connector 30 includes a clamping member 36. The flange 341 abuts against the first component 32. The clamping member 36 is disposed in the recess 342 and abuts against an outer surface of the sleeve 35.

Specifically, the clamping member 36 abuts against the outer surface of the sleeve 35, and the flange 341 hooks to and abuts against the first component 32. In this way, the flange 341 of the shaft 34 and the clamping member 36 are such disposed that the shaft 34 can connect the first component 32, the second component 33, the elastic member 31 and the sleeve 35 together as an integral assembly. When the rotating connector 30 needs to be removed, the entire rotating connector 30 can be removed by removing only the first component 32, without a need to individually remove each component, thereby facilitating disassembly.

Still referring to FIG. 7 to FIG. 10, in some exemplary embodiments, one side of the first component 32 is provided with a first convex-concave part 321, and one side of the second component 33 is provided with a second convex-concave part 331. The first convex-concave part 321 and the second convex-concave part 331 may be engaged with each other. When the first arm 211 and the second arm 212 rotate relative to each other, the first component 32 and the second component 33 rotate relative to each other. The first convex-concave part 321 and the second convex-concave part 331 are configured to jointly cause the first component 32 and the second component 33 to translate away from each other.

Specifically, referring to FIG. 8, when no external force is applied to the second arm 212, a concave portion of the first convex-concave part 321 may be engaged with a convex portion of the second convex-concave part 331, and a convex portion of the first convex-concave part 321 may be engaged with a concave portion of the second convex-concave part 331, so that the first component 32 is engaged with the second component 33 to lock the relative positions of the first arm 211 and the second arm 212. When the second arm 212 is under an action of an external force to rotate relative to the first arm 211, the second arm 212 drives the sleeve 35 to rotate, to drive the second component 33 to rotate relative to the first component 32, and the convex portion of the first convex-concave part 321 rotates to a position at which the convex portion of the first convex-concave part 321 abuts against the convex portion of the second convex-concave part 331, so that the first component 32 and the second component 33 translate away from each other to cause the first component 32 to disengage from the second component 33, thereby allowing the second arm 212 to rotate around the first arm 211 smoothly.

It may be understood that, in some exemplary embodiments, the rotating connector 30 may also include a damping shaft assembly. Specifically, the shaft assembly may be a damping component such as a rotary damper. Usually, in such an implementation, the damping shaft assembly includes a damping shaft and a rotating shaft rotatably connected to the damping shaft. The damping shaft is configured to apply resistance to the rotating shaft to prevent the rotating shaft from rotation. The rotating shaft can rotate around the damping shaft under a sufficiently large external force. In such an implementation, the damping shaft may be connected to one of the first arm 211 and the second arm 212, and the rotating shaft may be connected to the other one of the first arm 211 and the second arm 212. When no external force is applied to the second arm 212, the damping shaft can prevent rotation of the second arm 212, thereby preventing interference to operation of the handheld gimbal 100. When the handheld gimbal 100 needs to be folded, the second arm 212 is under an action of an external force, so that the second arm 212 overcomes the resistance of the damping shaft to rotate relative to the first arm 211, so as to fold the handheld gimbal 100.

In addition, in some exemplary embodiments, the handheld gimbal 100 may not be provided with the rotating connector 30. The handheld gimbal 100 may include a motor for state switching, and can change the angle between the first arm 211 and the second arm 212 by using the motor. For example, the motor is disposed on the first arm 211, a motor shaft of the motor is fixedly connected to the second arm 212, and the motor is configured to drive the second arm 212 to rotate relative to the first arm 211. Specifically, when there is no need to fold the handheld gimbal 100, the motor shaft of the motor does not rotate, to prevent the second arm 212 from rotation, so that the second arm 212 remains relatively non-rotating to the first arm 211. When the handheld gimbal 100 needs to be folded, the motor is started, and the motor shaft rotates to drive the second arm 212 to rotate relative to the first arm 211, so as to fold the handheld gimbal 100. In this way, when the handheld gimbal 100 needs to be folded, there is no need to manually apply a force to the second arm 212, but instead, the motor is used to directly control rotation of the second arm 212, thereby improving user experience.

Referring to FIG. 7 to FIG. 10 again, in some exemplary embodiments, the rotating connector 30 further includes a first cover 37 and a second cover 38, and each first convex part 2111 is provided with a through hole 2112. The first component 32 is located in one of the through holes 2112. The first cover 37 is mounted in one of the through holes 2112 and is connected to the first component 32. The second cover 38 is mounted in the other through hole 2112.

Specifically, the first cover 37 is removably mounted to the through hole 2112 in which the first component 32 is located. The first cover 37 may abut against the first component 32 to prevent the first component 32 from disengaging from the through hole 2112 under an action of the elastic member 31. In addition, when a part of the rotating connector 30 needs to be replaced or the rotating connector 30 needs to be removed, the first cover 37 may be removed to replace or repair the part of the rotating connector 30, for example, to replace the first component 32 and the elastic member 31.

In some exemplary embodiments, a housing of the handheld part 10 may be provided with a function key and/or a touch display screen. A controller and a related circuit (not shown) for controlling operation of the handheld gimbal 100 are disposed inside the handheld part 10. The function key and the touch display screen are in communication connection with the controller. The controller may receive a user instruction from the function key or the touch display screen, and controls the operation of the handheld gimbal 100 according to the user instruction. The function key includes, but is not limited to, a switch key, a menu key, a shooting key, or other function keys.

In some exemplary embodiments, for holding easily, the handheld part 10 may be further provided with a non-slip portion to prevent the handheld gimbal 100 from slipping off a user's hand. The non-slip portion may be a friction portion disposed on the handheld part 10 or a recessive portion or a protruding portion for an easy finger grip. It may be understood that the handheld part 10 may be further provided with a protective device that can be held on a user's finger or wrist, such as a finger ring or a wristband, to further protect the handheld gimbal 100 from slipping off the user's hand.

In addition, in some exemplary embodiments, to more accurately adjust a photographing angle of the photographing apparatus, the carrier 231 may be provided with a posture sensor to obtain posture information of the carrier 231, and obtain posture information of the load. The posture sensor is in communication connection with the controller to transfer the posture information of the photographing apparatus to the controller. The controller controls operation of the handheld gimbal 100 based on the attitude information of the photographing apparatus and a user instruction. The posture sensor may be a sensor capable of sensing the posture information of the photographing apparatus, such as a tri-axial gyroscope, a tri-axial accelerometer, or a tri-axial electronic compass.

In this disclosure, unless otherwise explicitly specified and defined, that a first feature is “above” or “under” a second feature may include that the first feature is in direct contact with the second feature, or that the first feature and the second feature are not in direct contact with each other but are in contact via another feature between them. In addition, that the first feature is “over”, “above”, or “on” the second feature includes that the first feature is directly above and diagonally above the second feature, or simply indicates that an altitude of the first feature is higher than that of the second feature. That the first feature is “beneath”, “below”, and “under” the second feature includes that the first feature is directly below and diagonally below the second feature, or simply indicates that the altitude of the first feature is lower than that of the second feature.

The disclosure herein provides a number of different implementations or examples used to implement different structures of this disclosure. To simplify the disclosure of this disclosure, components and dispositions of particular examples are described herein. Certainly, the descriptions are only examples and are not intended to limit this disclosure. In addition, reference numerals and/or reference letters may be repeated in different examples in this disclosure, and such repetition is for purposes of simplification and clarity, and is not indicative of relationships between the various implementations and/or dispositions discussed. In addition, while this disclosure provides examples of various specific processes and materials, a person of ordinary skill in the art may be aware of disclosures of other processes and/or use of other materials.

In the descriptions of this specification, a description with reference to the term “one embodiment”, “some embodiments”, “an exemplary embodiment”, “an example”, “a specific example”, “some examples”, or the like means that a specific feature, structure, material, or characteristic described in combination with the implementation(s) or example(s) are included in at least one implementation or example of this disclosure. In this specification, the schematic description of the foregoing terms does not necessarily refer to the same implementation or example. Moreover, the described specific feature, structure, material, or characteristic may be combined in an appropriate manner in any one or more implementations or examples.

Although some exemplary embodiments of this disclosure have been illustrated and described, a person of ordinary skill in the art can understand that various changes, modifications, replacements, and variants may be made to these exemplary embodiments without departing from the principle and purpose of this disclosure, and the scope of this disclosure is defined by the claims and equivalents of the claims.

What is claimed is:

1. A handheld gimbal, comprising:
a handheld part, including a top portion and a bottom portion;
a first shaft assembly, including a first arm and a first shaft motor connected to the top portion of the handheld part;
a second shaft assembly, including a second shaft motor and a second arm fixedly connected to the second shaft motor;
a rotating connector, disposed between the first arm and the second arm to allow the first arm and the second arm to rotate relative to each other;
a third shaft assembly, including a third shaft motor and a third arm, one end of the third arm being fixedly connected to the second shaft motor, and the other end of the third arm being fixedly connected to the third shaft motor; and
a carrier, fixedly connected to a rotor of the third shaft motor, wherein:
the handheld gimbal is configured to switch between a folded state and a deployed state,
in the folded state, the second shaft assembly, the third shaft assembly and the carrier are located on a same lateral side of the handheld part,
in the deployed state, the second shaft assembly, the third shaft assembly and the carrier are located on a same longitudinal side of the handheld part, and a rotation axis around which the first arm and the second arm rotate relative to each other is perpendicular to a length direction of the first arm.

2. The handheld gimbal according to claim 1, wherein in the folded state, the second arm and the third arm are arranged sequentially in a direction away from the handheld part.

3. The handheld gimbal according to claim 1, wherein the first shaft motor rotates around a first axis,
the second shaft motor rotates around a second axis, and
the third shaft motor rotates around a third axis.

4. The handheld gimbal according to claim 3, wherein in the deployed state, the first axis, the second axis and the third axis are non-orthogonal to each other; and
in the folded state, the first axis and the third axis are orthogonal to each other, and the first axis and the second axis are non-orthogonal to each other.

5. The handheld gimbal according to claim 4, wherein in the folded state, an angle between the second axis and the first axis is an acute angle.

6. The handheld gimbal according to claim 3, wherein the second arm includes:
a first segment connected to the rotating connector; and
a second segment connected to the second shaft motor and being at an angle with respect to the first segment; and
an angle between the second axis and an extension direction of the first segment corresponds to an angle between the second axis and an extension direction of the third arm.

7. The handheld gimbal according to claim 1, wherein in the folded state, the carrier is located on a side of the third shaft motor away from a side wall of the handheld part.

8. The handheld gimbal according to claim 7, wherein the carrier includes a carrying portion configured to fix a photographing apparatus; and
in the folded state, the carrying portion is located on the side of the third shaft motor away from the side wall of the handheld part.

9. The handheld gimbal according to claim 8, wherein the carrying portion is a clamping structure or a magnetic structure; and
in the folded state, an opening of the clamping structure is disposed facing away from the third shaft motor.

10. The handheld gimbal according to claim 9, wherein the clamping structure includes a locked state and an unlocked state;
in the unlocked state, the clamping structure is configured to clamp and fix the photographing apparatus, and the third shaft motor is configured to rotate around a third axis; and
in the locked state, the clamping structure is locked to the third arm to limit the third shaft motor from rotating.

11. The handheld gimbal according to claim 3, wherein the second shaft assembly includes a second shaft motor,
the third arm is connected to the second shaft motor and the third shaft assembly,
the second shaft motor is configured to drive the third shaft assembly to rotate around the second axis, and
a radius by which the third shaft assembly rotates around the second axis is shorter than a length of the third arm.

12. The handheld gimbal according to claim 1, wherein in the deployed state, an angle formed between the first arm and the second arm is an obtuse angle.

13. The handheld gimbal according to claim 1, wherein in the folded state, the second arm is parallel to the handheld part, or
an angle formed between the second arm and the handheld part is an acute angle.

14. The handheld gimbal according to claim 1, wherein the first shaft assembly is a yaw-axis assembly, the second shaft assembly is a pitch-axis assembly, and the third shaft assembly is a roll-axis assembly.

15. The handheld gimbal according to claim 1, wherein the rotating connector includes
a first component disposed on the first arm;
a second component disposed on the second arm, wherein the first component and the second component are configured to rotate relative to each other; and
an elastic member connected to the first component or the second component to drive the first component and the second component to engage with each other, so as to lock relative positions of the first arm and the second arm.

16. The handheld gimbal according to claim 15, wherein one end of the first arm includes two first convex parts spaced opposite to each other,
one end of the second arm includes a second convex part, the second convex part is at least partially located between the two first convex parts,
the elastic member is connected to the second component,
the rotating connector includes a shaft and a sleeve, the sleeve is at least disposed through the second convex part and is fixedly connected to the second convex part,
the second component and the elastic member are accommodated in the sleeve, and
the shaft of the rotating connector is disposed through the first component, the second component and the elastic member.

17. The handheld gimbal according to claim 16, wherein the rotating connector includes a first cover and a second cover,
each of the first convex parts includes a through hole, the first component is located in one of the through holes,
the first cover is mounted in the one of the through holes and connected to the first component, and
the second cover is mounted in the other through hole.

18. The handheld gimbal according to claim 16, wherein one end of the shaft of the rotating connector includes a ring-shaped flange,
the other end of the shaft of the rotating connector includes a recess,
the rotating connector includes a clamping member,
the flange abuts against the first component, and
the clamping member is disposed in the recess and abuts against an outer surface of the sleeve.

19. The handheld gimbal according to claim 15, wherein one side of the first component includes a first convex-concave part,
one side of the second component includes a second convex-concave part engaged with the first convex-concave part, and
in response to the first arm and the second arm rotating relative to each other,
the first component and the second component rotate relative to each other, and
the first convex-concave part and the second convex-concave part jointly cause the first component and the second component to translate away from each other.

20. The handheld gimbal according to claim 1, wherein the rotating connector includes a damping shaft assembly.
